(19) United States
(12) Patent Application Publication
(10) Pub. No.: US 2019/0373028 A1
(43) Pub. Date: Dec. 5, 2019

(54) COMPUTER IMPLEMENTED METHOD AND SYSTEM FOR VIRTUAL OFFICE MANAGEMENT

(71) Applicant: Murali Krishna Kasula, Cerritos, CA (US)

(72) Inventor: Murali Krishna Kasula, Cerritos, CA (US)

(21) Appl. No.: 15/996,551

(22) Filed: Jun. 4, 2018

(51) Int. Cl. H04L 29/06; G06F 9/451; G06F 17/30; G06F 3/0482; G06F 3/14; G06F 3/0484

(52) U.S. Cl. CPC H04L 65/403; G06F 9/452; G06F 17/30598; G06F 3/0484; G06F 3/0482; G06F 3/1454; G06F 17/30867

(57) ABSTRACT

Exemplary embodiments of the present disclosure are directed towards a computer implemented method and system for facilitating communications. The system comprising: a processor-based application, which when executed on an end-user device, will cause the end-user device to: login a virtual office platform by a first end-user. Generate search results in the virtual office platform after providing an input query, the input query provided by at least one first end-user. Initiate a conversation with a second user by the first end-user through a plurality of different communications, the plurality of different communications are provided by a video communication option, a data communication option, and an audio communication option. Share a screen to the second end-user by the first end-user, the first end-user is configured to select a list of classified end-users and send a request to the selected list to initiate a multi-user discussion.

### TECHNICAL FIELD

The disclosed subject matter relates generally to virtual management systems and computer implemented methods. More particularly, the present disclosure relates to a system and computer implemented methods for organizing and managing end-user activities in a virtual office environment.

### BACKGROUND

When face-to-face communications are not practical, people often rely on technological solutions to meet their communication needs. Traditional telephony systems are configured to enable voice communications between users (for e.g., callers). Moreover, some instant messaging communications systems enable users to communicate text messages in real time through computing devices interconnected by an instant message server. Currently existing solutions (for e.g., computer applications) are available to facilitate communication between end-users. The computer applications can be used for monitoring user activities such as reading mail written by an end-user, viewing websites visited by an end-user, recording a user's keystrokes, logging inactivity timeouts, capturing information through screen shots, etc.

However, in corporate organizations, end-users (for e.g., employees) communicate with each other to perform the assigned tasks and meetings. The end-users are in different time zones and are required to communicate with each on a more consistent basis. For e.g., if an employee has meeting with the client at a particular time, meanwhile, he has some other board meeting with superiors. It is very difficult to him to attend the both sessions at a time. The corporate organizations have long desired a platform that enables end-users to communicate more efficiently, yet provide structure that gives end-users (for e g, managers and employees) ready access to all the disparate resources available to them. Currently, the available multiple software systems and applications are not able to organize and manage end-user activities in real time. Currently, the available multiple software systems and applications are configured to access end-users, resources, and documents. But, the end-users are not able to perform activities with the available solutions. Integrating a combination of these features has been challenging.

In the light of aforementioned discussion, there exists a need for certain system with a novel methodology that would overcome the above-mentioned disadvantages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards connecting a plurality of end-users at a time to establish communication.

Another objective of the present disclosure is directed towards facilitating communication with end-users, schedule meetings, announcements, archives, and generate visualizations on a periodic basis.

Another objective of the present disclosure is directed towards providing all the needed information of the end-users in a single dashboard and empowering the end-users to connect to other end-users in a virtual office platform.

Another objective of the present disclosure is directed towards organizing and managing end-user activities in real time.

Another objective of the present disclosure is directed towards accessing the virtual office platform without installing or downloading any software at the end-user device.

In one embodiment of the present disclosure, a system comprises at least one end-user device configured to access the virtual office platform by at least one first end-user.

In another embodiment of the present disclosure, the system further configured to initiate a conversation with at least one second end-user by the at least one first end-user through a plurality of different communications, the plurality of different communications are provided by at least one video communication option, at least one data communication option, and at least one audio communication option.

In another embodiment of the present disclosure, the system configured to generate search results after providing an input query, the input query provided by the at least one first end-user.

In another embodiment of the present disclosure, the system further configured to share a first end-user's screen to the at least one second end-user by the at least one first end-user, the at least first end-user configured to select a list of classified end-users and send a request to the selected list to initiate a multi-user discussion.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a diagram depicting an exemplary environment in which various embodiments disclosed herein may be implemented. Specifically, FIG. 1 depicts a schematic representation of environment for organizing and managing end-user activities.

FIG. 2 is a diagram depicting the virtual office platform 102 shown in FIG. 1, in accordance with one or more embodiments.

FIG. 3A is an example diagram depicting a home screen, in accordance with one or more embodiments.

FIG. 3B is an example diagram depicting a profile option 302 shown in FIG. 3A, in accordance with one or more embodiments.

FIG. 3C-FIG. 3D are example diagrams depicting a directory option 304 shown in FIG. 3A, in accordance with one or more embodiments.

FIG. 3E is an example diagram depicting an announcement option 306 shown in FIG. 3A, in accordance with one or more embodiments.

FIG. 3F is an example diagram depicting a meeting option 308 shown in FIG. 3A, in accordance with one or more embodiments.

FIG. 3G is an example diagram depicting the whiteboard screen, in accordance with one or more exemplary embodiments.

FIG. 3H is an example diagram depicting an activities option 310 shown in FIG. 3A in accordance with one or more embodiments.

FIG. 3I-FIG. 3J are example diagrams depicting an admin option 370, in accordance with one or more embodiments.

FIG. 4A-FIG. 4B are example diagrams depicting a reports option 312 shown in FIG. 3A, in accordance with one or more embodiments.

FIG. 4C is an example diagram depicting a bubble chart, in accordance with one or more embodiments.

FIG. 5 is an example diagram depicting an archives option 314 shown in FIG. 3A, in accordance with one or more embodiments.

FIG. 6 depicts a more detailed view, of the computing devices shown in FIG. 1, in accordance with one or more embodiments.

FIG. 7 is a flow diagram depicting a method for facilitating communications, in accordance with one or more embodiments.

FIG. 8 is a flow diagram depicting a method for generating visualizations (for e.g., time log reports), in accordance with one or more embodiments.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

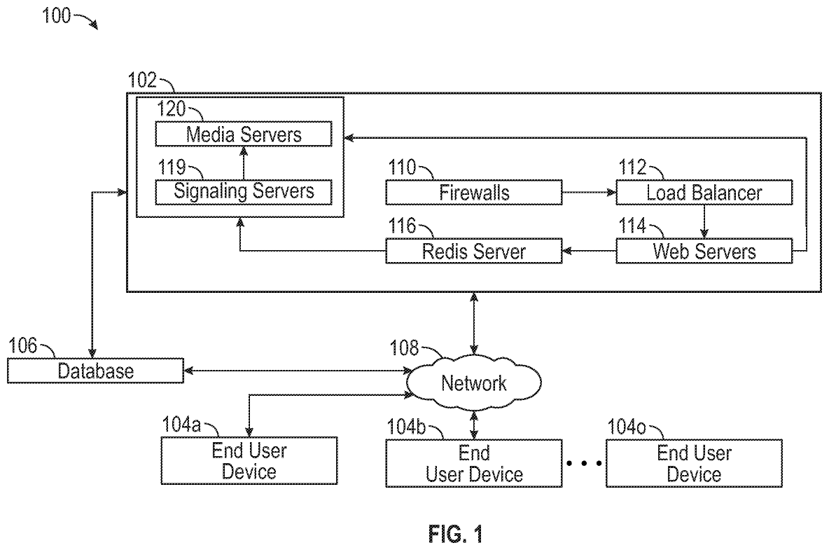

Referring now to the drawings wherein like numerals represent like elements throughout the several figures, FIG. 1 is a diagram depicting an exemplary environment in which various embodiments disclosed herein may be implemented. Specifically, FIG. 1 depicts a schematic representation of environment 100 for organizing and managing end-user activities from real time locations. The environment 100 may include, a virtual office platform 102, end-user devices 104a-104o, a database 106, and a network 108. The end-user devices 104a-104o may include a device such as a personal computer, a workstation, an electronic book reader, a personal digital assistant, a mobile station, mobile phones, computing tablets, and the like. When the end-user devices 104a-104o correspond to mobile devices (e.g., mobile phones, tablets etc.), and the applications (e.g. the virtual office platform 102) are accessed as mobile applications, web applications, software that offers the functionality of accessing mobile applications, and viewing/processing of interactive pages, for example, is implemented in the end-user devices 104a-104o as will be apparent to one skilled in the relevant arts by reading the disclosure provided herein. The network 108 may include, but not limited to, an ethernet, a wireless local area network (WLAN), or a wide area network (WAN), a Wi-Fi communication network e.g., the wireless high-speed internet, or a combination of networks, a cellular service such as a 4G (e.g., LTE, mobile WIMAX) or 5G cellular data service. The network 108 may provide transmission of data and/or information via a control protocol, a hypertext transfer protocol, a simple object access protocol or any other internet communication protocol. The organizing and managing end-user activities may include, for example, communication with end-users, schedule meetings, announcements, archives, and generate visualizations on a periodic basis, and the like. The end-users may able to create, update, and reassign the activities on the virtual office platform 102 and also the end-users may track the spending time against the activities. The end-user such as an employee, a manager, a staff member, an organization, a team member, an administrator, and the like. The virtual office platform 102 may be a browser based platform, without download or installation required that makes it strong on the information technology security. The virtual office platform 102 is real time and always-on platform.

The virtual office platform 102 may include firewalls 110, a load balancer 112, and web servers 114, a redis server 116, signaling servers 119, media servers 120, and the like. The firewalls 110 may be configured to monitor and control incoming and outgoing network traffic based on predetermined security rules. The firewalls 110 may also be configured for protecting network resources from undesired network traffic. The load balancer 112 may be configured for distributing server load across the web servers 114. The web servers 114 may be configured to establish communication between an Nginx server and the database 106. The redis server 116 may be configured to store sessions, and store active conferences. The database 106 may store users' details, teams' details, announcements, meetings, profiles, and other user data. The signaling servers 119 may include webRTC servers and the media conference servers 120 may include application servers. The end user device 104a-104o may send a request to the signaling servers 119 to establish a communication to another end user device 104a-104o. The end user device 104a-104o may send the real-time data to each other through the media servers 120. The media servers 120 may be configured for routing the communications between the end user devices 104a-104o.

The end-users may allow to access the virtual office platform 102 by entering login identity credentials. The credentials may include a unique identifier or identifiers of the virtual office platform 102. For example identifiers may include, a username, an email address, an account identity, a mobile number, and the like. A secured code associated with an identifier may include a password, a symmetric encryption key, biometric values, a passphrase, and the like. The virtual office platform 102 may be configured to facilitate communications between the end-users. The communications may be performed between the end-users by the communication options on the virtual office platform 102. The communication options may include, but are not limited to, a video communication, a data communication, an audio communication, a share screen, and the like. Once the end-user logged into the virtual office platform 102, the user's live status and live image may be displayed on the profile screen. The live status may include, but is not limited to, an online mode, an offline mode, and the like. The live image may be captured by a capturing device and it may be updated within a predefined time limit on the virtual office platform 102. The virtual office platform 102 may be configured to organize and manage the end-user activities, for example, a virtual meeting room is created to conduct meetings or conferences or discussions either in public mode or private mode. The conference calls may not require the end-users to approve the call. The activities may be organized based on predefined or ad hoc based activities. The virtual office platform 102 may be configured to provide the end-user work related information. The end-user work related information may include, but is not limited to, name of end-user, location, status, work hours, time zone, with an option start a video, audio, text, or screen share connect from a click of a button, and the like. The end-user may able to quit the virtual meeting room by a toggle conference option in the virtual office platform 102. The end-user may control the virtual meeting room, for example, an end-user who initiated the meeting can have all control over the virtual meeting room. The virtual office platform 102 may be configured to provide a public mode of action and a private mode of action. The public mode of action may allow any end-user who registered with the virtual office platform 102 to join in the virtual meeting room. For e.g., if the first end-user is interacting with the second end-user in the virtual meeting room, a third end-user who registered with the virtual office platform 102 may join the virtual meeting room when the public mode of action is activated. The private mode of action may restrict the certain end-user and only allows group of end-users. The virtual office platform 102 may automatically pull the desired team into the virtual meeting room unless any individual put their status busy.

The virtual office platform 102 may be configured to create a dashboard to provide an interaction platform for the end-users. The dashboard may be a personalized panel of the end-user where the end-user video profiles are shown by fetching the details from the virtual office platform 102. The end-user (for e.g., administrator) may create the teams and maps the end-users (for e.g., employees) to the created teams which may enable to the end-user to view the end-users (for e.g., the team members) in the corresponding dashboards. The dashboard may display the end-user's vital information, for example, location, time zone, status, work hours, etc with an option start a video, audio, text, or screen share connect from a click of a button. The end-user may sort the end-users (for e.g., team members) based on the alphabetical order, status, etc. The dashboard may give user an option to view ongoing meetings, search employees in the directory, send notifications to the end-users (for e.g., team members) using announcement boards, schedule meetings, create activities and link them to meetings, view historical information of chats, announcements, meetings, and the like along with the special ability to view reports of the end-users (for e.g., team members) and align manage users and teams if the end-user is an administrator. The video profile in the dashboard is a continuous stream of video which ensures that the remote user is always in front of the virtual office platform 102 to attend meetings when needed. Using connect all, the end-user may directly connect to all the end-users (for e.g., team members) using different connect options. Multiple end-users may be selected by clicking on the + symbol on the video profiles and finally click on connect selected to start a meeting.

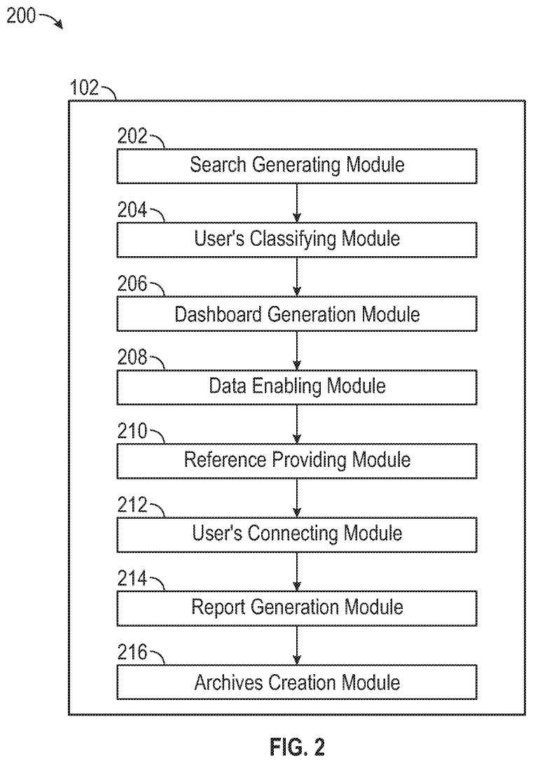

Referring to FIG. 2, FIG. 2 is a diagram 200 depicting the virtual office platform 102 shown in FIG. 1, in accordance with one or more embodiments. The virtual office platform 102 may further include a search generating module 202, a user's classifying module 204, and a dashboard generation module 206, a data enabling module 208, a reference providing module 210, and a user's connecting module 212, a report generation module 214, and a archives creation module 216.

The search generating module 202 may be configured to generate the search results based on an input query provided on a search bar by the end-user. The user's classifying module 204 may be configured to classify the end-users in different formats. The different formats may include, but are not limited to, people online, people offline, people in public meeting, people in private meeting, people away, people with DND, naming A to Z, naming Z to A, and the like. The dashboard generation module 206 may provide information about users' participation in multiple meetings. Multiple communications (for e.g., text chats and file transfers) may be performed between individual end-users level and the jointly team level by the data enabling module 208. The dashboard generation module 206 may be configured to switch the end-users to other end-users dashboards. For e.g., if a first end-user have an access to his dashboard, and then the first end-user may also access other end-user dashboards in real time. The reference providing module 210 may be configured to provide quick guidelines to the end-users to perform various actions. The user's connecting module 212 may be configured to connect with multiple end-users in real time. The report generation module 214 may be configured to generate reports (e.g., visualizations) on a periodic basis (for e.g., daily or weekly or monthly or yearly). The archives creation module 216 may be configured to create archives for announcements data, meetings data, and activities data.

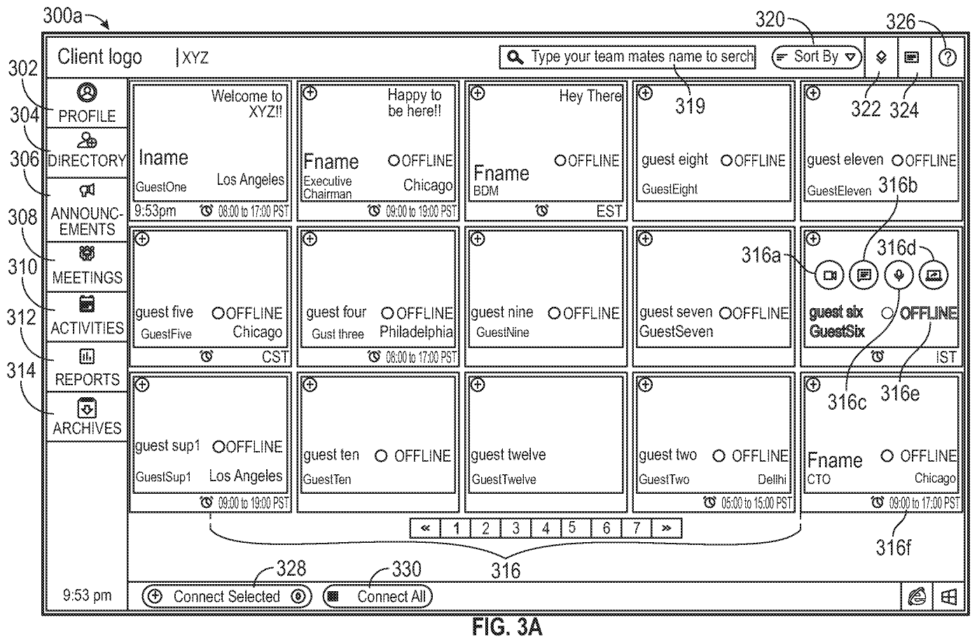

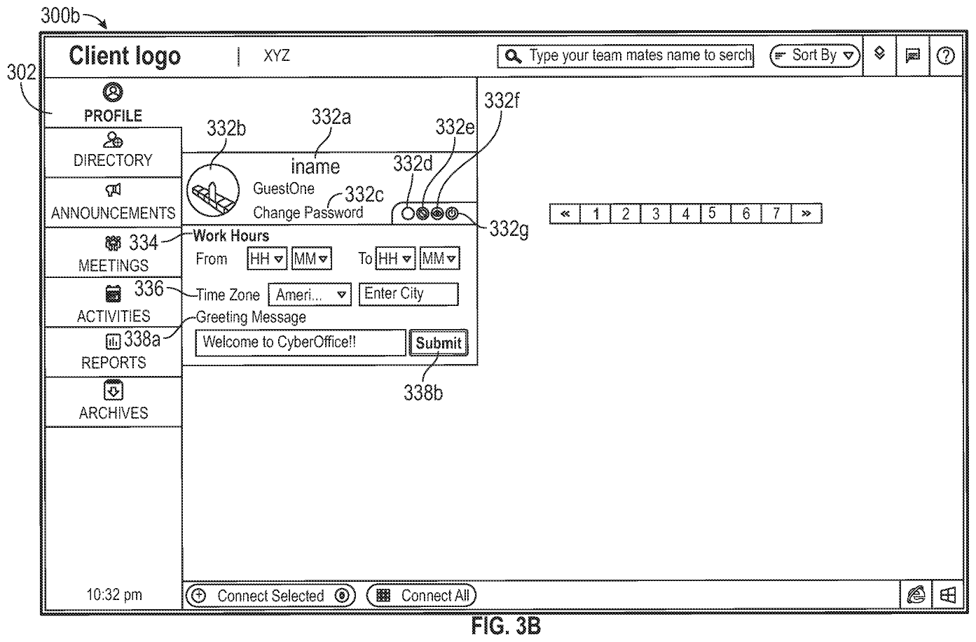

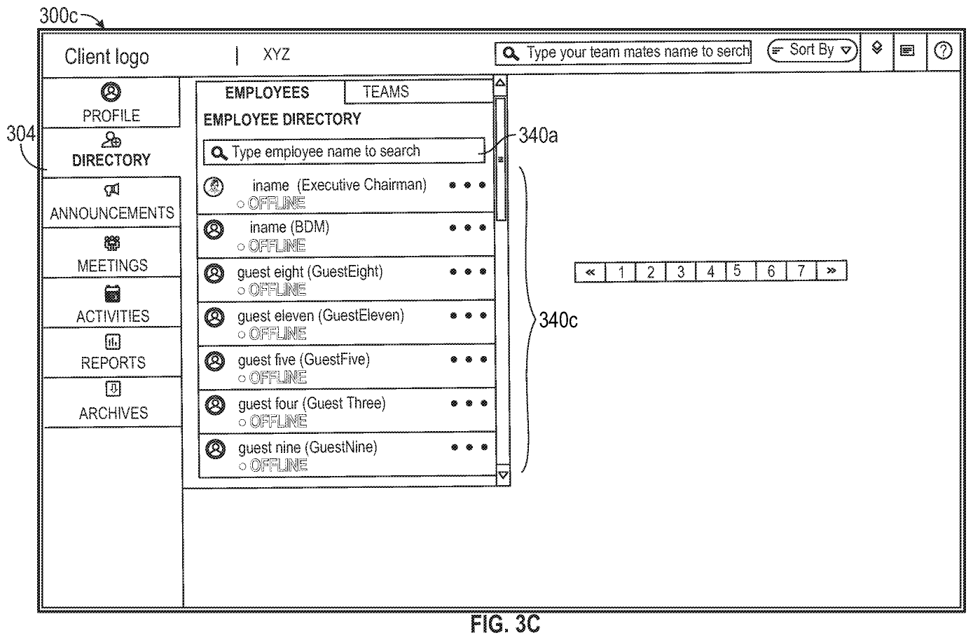

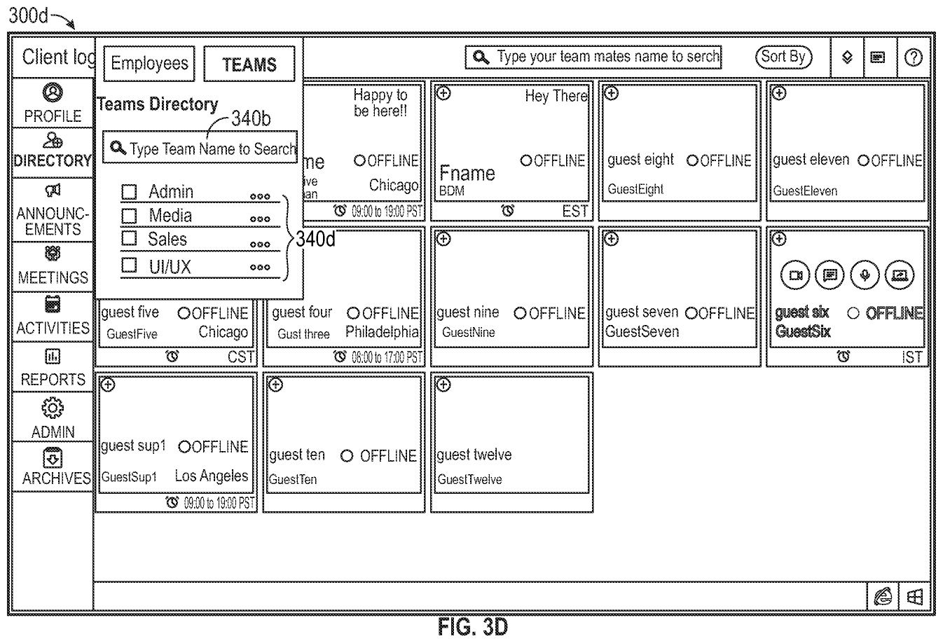

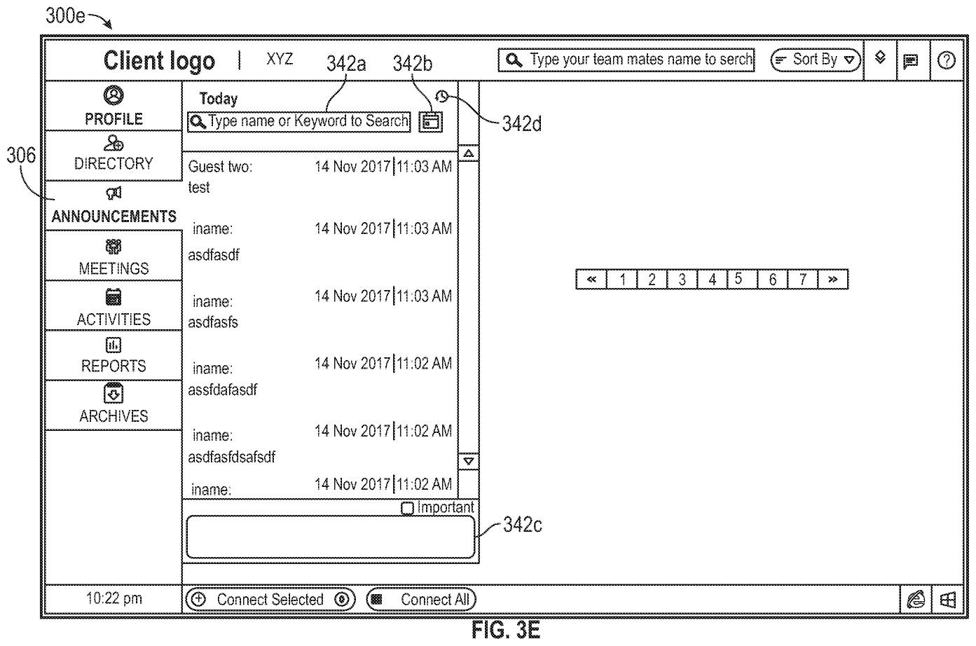

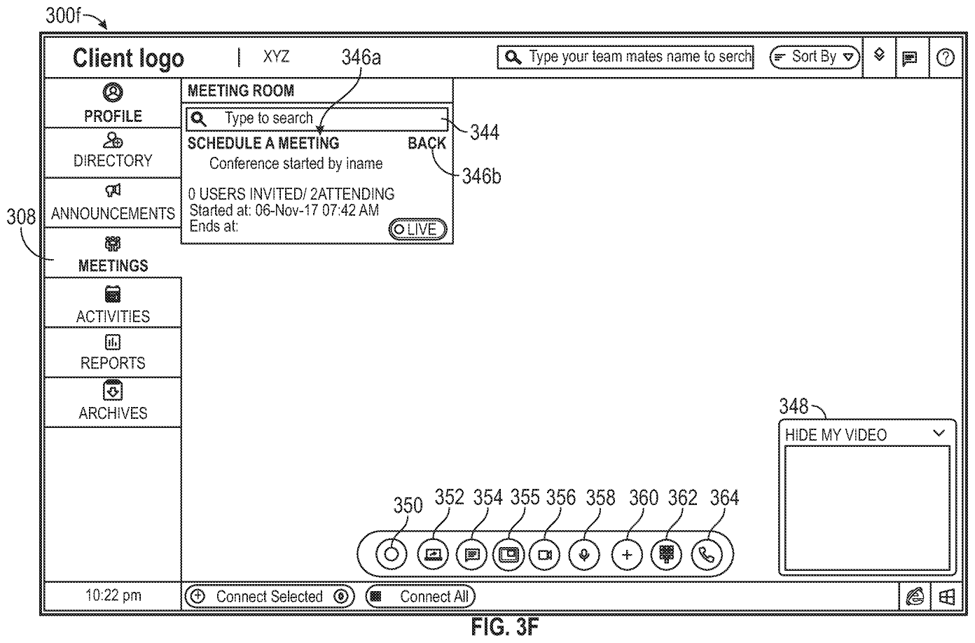

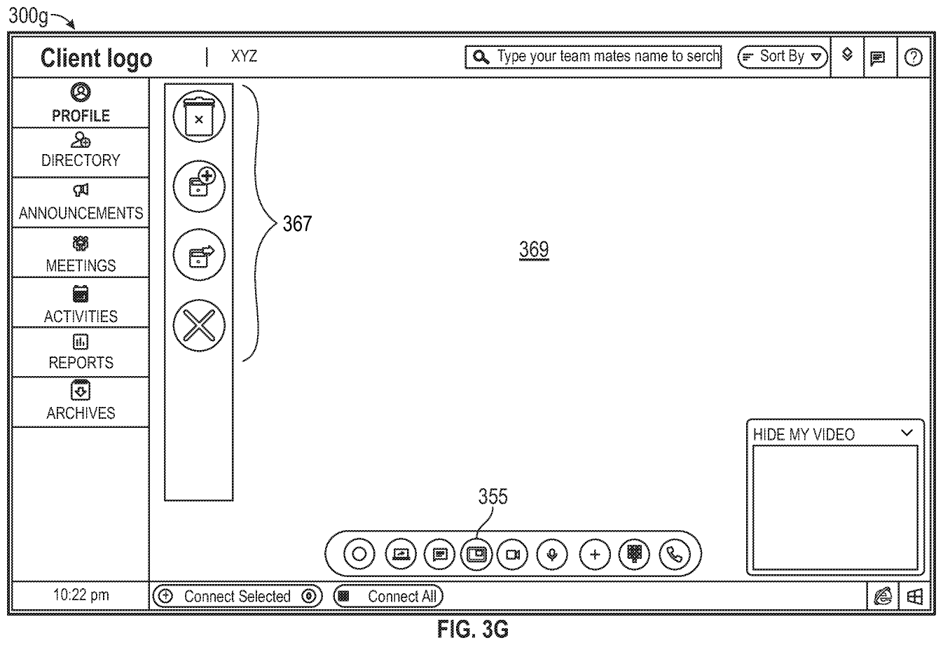

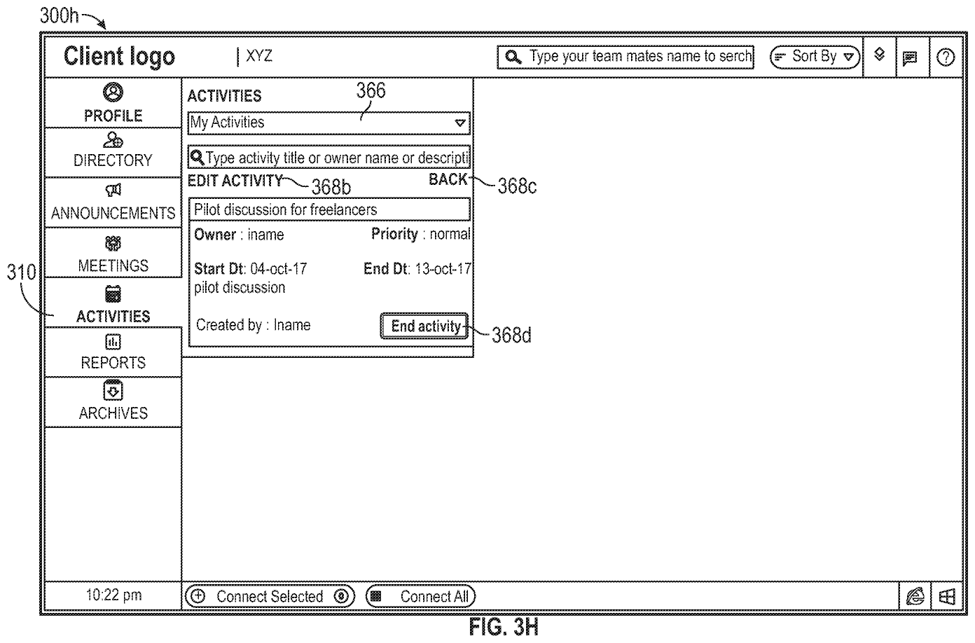

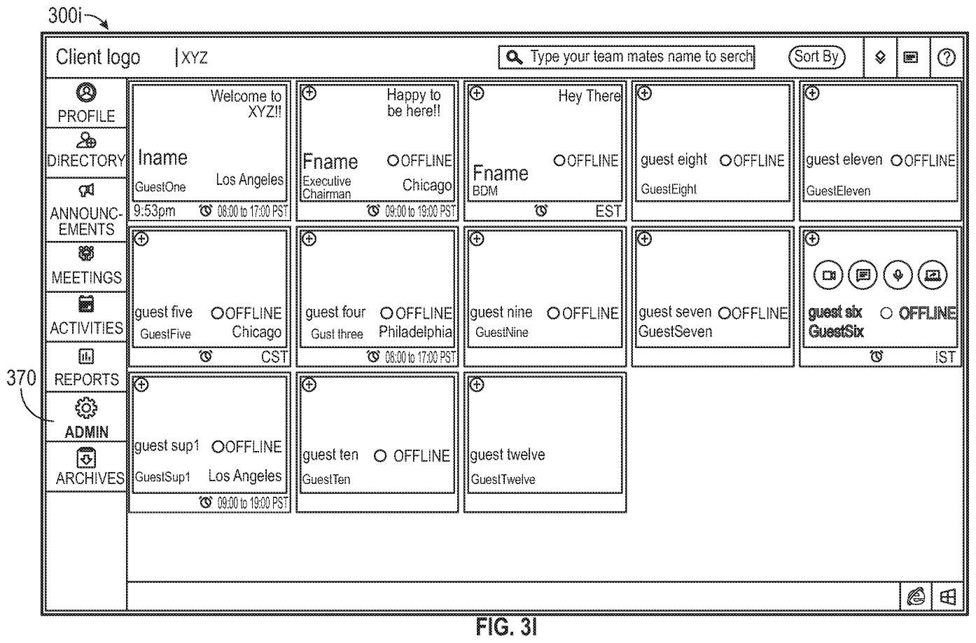

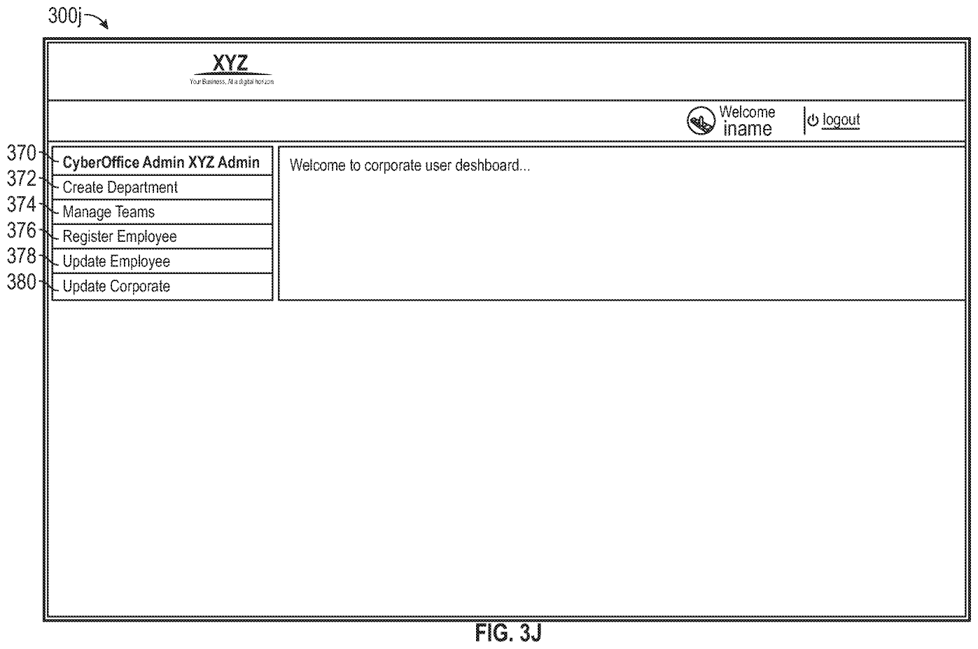

Referring to FIG. 3A, FIG. 3A is an example diagram 300a depicting a home screen in accordance with one or more embodiments. Once the end-user (for e.g., end-user A) login with identity credentials in the end-user device 104a-104o, then a home screen 300a may be depicted. The home screen 300a may include a profile option 302, a directory option 304, an announcements option 306, a meetings option 308, an activities option 310, a reports option 312, an archives option 314, end-users screens 316, a search bar 319, a sort field 320, a dashboard 322, a chat option 324, a help option 326, a connect selected option 328, and a connect all option 330. The profile option 302 may be configured to provide a virtual curtain between the camera and the end-user so that the end-users may not be seen completely (instead a shady image of the real person appears). The directory option 304 may be configured to identify an employee directory, a team directory, a list of employees' directory, and a list of team directory. The announcement option 306 may enable notices (for e.g., company level notice). The meeting option 308 may provide different options. The activities option 310 may be configured to provide different activities and other options to the end-users. The report option 312 may be configured to set a particular time period based on a periodic basis. The archives option 314 may also be configured to set the particular time period to know about the announcements, meetings, and activities. The end-users' screens 316 may include multiple screens, for e.g., end-user A, end-user B, end-user C, end-user D, end-user E, end-user F, end-user G, end-user H, end-user I, end-user J, end-user K, end-user L, end-user M, end-user N, end-user O and the like. Each end-user screen 316 may depict a video communication icon 316a, a data communication icon 316b, an audio communication icon 316c, a share screen (or desktop) option 316d, a live status 316e (for e.g., online or offline), and work hour's option 316f. The home screen 300a may also depict an admin option 370 configured to add or register the end-users, create new departments and manage team. The video communication icon 316a may enable the end-user to implement a video communications, video messages, with other end-user. The data communication icon 316b may be configured for transmission and reception of the data between the end-users. The audio communication icon 316c may be configured to enable the end-user to communicate with other end-user. The share screen option 316d may be enabled to share the screen between the end end-users. The live status 316e may depict the end user's live status. The work hour's option 316f may depict the number of working hours of the end-users in the virtual office environment.

The search bar 319 may be displayed at a top portion of the end-user's screen (for e.g., user A). The search bar 319 may further include a search screen for entering a search query. The search query may include names of users. After entering the search query, the end-user may select a search control to request a search. The sort field 320 may be configured to sort the list of end-users. The sort field 320 may include sort options, for example, people online, people offline, people in public meeting, people in private meeting, people away, people with DND, naming A to Z, naming Z to A, and the like. The dashboard 322 may be configured to present profiles of end-users participating in meetings. The dashboard 322 may include, for example, a team information field. The team information field may be populated with information indicating a hierarchy of teams, who are participating in the meeting. The chat option 324 may be configured to enable multiple text chats and file transfers between individual end-users level and the jointly team level. The help option 326 may be configured to provide quick guidelines to the end-user after selecting it. Connect selected option 328 may use to connect with multiple end-users same time after selecting the end-users. The connect all option 330 may connect the end-user with other all end-users of the team.

Referring to FIG. 3B, FIG. 3B is an example diagram 300b depicting the profile option 302 shown in FIG. 3A in accordance with one or more embodiments. If the end-user clicks on the profile option 302, then it may depict a profile name 332a, a profile picture 332b, a change password option 332c, and a blur off icon 332d, a DND on icon 332e, an away icon 332f, and a logout icon 332g. The profile name 332a may be configured to provide the end-user profile name. The profile picture 332b may be configured to provide the end-user profile picture. The change password option 332c may be configured to enable the end-user to change the current password. The blur off icon 332d may enable to set a blur level off after tapping on it. The DND on icon 332e may be configured to activate the do not disturb status. Once the DND on icon 332e has been activated, the end-user is unreachable until the end-user returns to active status. The away icon 332f may be configured to activate away mode. The away mode may be used when the end-user will be away for an extended period of time. The logout option 332g may be configured to enable the end-user to logout from the screen. The profile option 302 further includes a work hour's field 334, a time zone indicator 336, a greeting field 338a and a submit option 338b. The work hour's field 334 may depict in a variety of formats, according to the need of the end-user, including hours in tenths or quarters of an hour, minutes in whole minutes or decimal portion of an hour, a 24 hour format, and other formats. The time zone indicator 336 may indicate or identify a particular time zone corresponding to a location. The time zone characters, for example, EST, EDT, CST, CDT, MST, MDT, IST, PST, or PDT. The greeting field 338a may allow the end-user to specify a default message or to enter personalized messages for each contact. The submit option 338b may be configured to enable the end-user to submit after providing all the data.

Referring to FIG. 3C-FIG. 3D, FIG. 3C-FIG. 3D are example diagrams 300c-300d depicting the directory option 304 shown in FIG. 3A in accordance with one or more embodiments. If the end-user clicks on the directory option 304, then it may depict an employee directory search bar 340a, a team directory search bar 340b, a list of employees 340c, and a list of teams 340d. The search bars 340a-340b may further include search windows for entering a search query. The search query may include, but not limited to, employee names, team names, and the like. The employee directory search bar 340a and the team directory search bar 340b may be configured to perform the search after providing the search query on the search windows and then selecting the search icon. Once the search is performed, the list of employees 340c and the list of teams 340d may be appeared. The list of employees 340c depicts the employee names and the list of teams 340d depicts the team names.

Referring to FIG. 3E, FIG. 3E is an example diagram 300e depicting the announcement option 306 shown in FIG. 3A in accordance with one or more embodiments. If the end-user clicks on the announcement option 306, then it depicts a search bar 342a, a calendar format 342b, a chat window 342c, and an old message restore option 342d. The search bar 342a may be configured to perform the search after providing the search query on the search window and then selecting the search icon. The calendar format 342b may provide a calendar information. The calendar information, for example in an MS exchange format, a google calendar format, or another standard calendar format. The chart window 342c may be configured to facilitate communication between the end-users. The old message restore option 342d may be configured to restore the old messages after selecting the old message restore option 342d by the end-user.

Referring to FIG. 3F, FIG. 3F is an example diagram 300f depicting the meeting option 308 shown in FIG. 3A in accordance with one or more embodiments. If the end-user clicks on the meeting option 308, then it may depict a search bar 344, a schedule meeting option 346a, a back option 346b and a hide my video option 348. The meeting option 308 may further depicts a record icon 350, a begin share icon 352, a text chat icon 354, a whiteboard icon 355, a disable video icon 356, a mute audio icon 358, an add end-user icon 360, a dial number icon 362, and a disconnect icon 364. The search bar 344 may be configured to perform the search after providing the search query on the search window and then selecting the search icon. If the end-user selects the schedule meeting option 346a and then the schedule meeting option 346a may depict a title, participants, an agenda, a start time, an end time, and the like. If the end-user selects the back option 346b and then the back option 346b may bring the end-user to the initial screen 300f. If the end-user clicks on the hide my video option 348 and then the video may be hided on the screen 300f. The record icon 350 may be configured to record the meeting after tapping on it and store the recorded data in archives. The begin share icon 352 may be enabled to share the screen with the end end-users (for e.g., meeting participants). If the end-user taps on the text chat icon 354 then it allow multiple text chats and file transfers between individual end-users' level and the team level. If the end-user selects the whiteboard icon 355, then a whiteboard appears (not shown) in part of end-user's screen. Once the disable video icon 356 is selected, then the video may be disabled to the end-user. The mute audio icon 358 may be configured to put the audio in mute. The add end-user icon 360 may be selected by the end-user to add number of end-users. The dial number icon 362 may include a keypad configured to make a call to the required end-users after dialling the number by the end-user. If the end-user selects the disconnect icon 364, then the live call may be disconnected.

Referring to FIG. 3G is an example diagram 300g depicting the whiteboard screen 300g, in accordance with one or more exemplary embodiments. The whiteboard screen 300g depicts the whiteboard icon 355. If the end-user selects the whiteboard icon 355 and then the selectable tools 367 and the whiteboard 369 may be appeared. The end-user may use the selectable tools 367 to write on the whiteboard 369, and to draw on the whiteboard 369, erase items off the whiteboard 369, save and close the whiteboard 369, and save and send the whiteboard 369. All other end-users in the team, if they have selected the whiteboard icon 355, may similarly view the whiteboard and may write on the whiteboard 369 and erase from the whiteboard 369. All other end-users in the team, may write on the whiteboard 369 at the same time.

Referring to FIG. 3H, FIG. 3H is an example diagram 300h depicting the activities option 310 shown in FIG. 3A in accordance with one or more embodiments. If the end-user clicks on the activities option 310, then the diagram 300h may depict the classified my activities 366, an add activity option 368a (not shown), an edit activity option 368b, a back option 368c, and an end activity icon 368d. The my classified my activities 366 may include, but is not limited to, my activities, team activities, all activities, archives, and the like. If the end-user selects the add activity option 368a (not shown), then the edit activity option 368b may be displayed. The edit activity option 368b depicts options which are a title, an owner name, a high priority, and a description, a start date, an end date, a submit option, an end activity, and the like. If the end-user selects the back option 368c and then the back option 368c may bring the end-user to the initial screen 300h. If the activity is ended, then the end-activity icon 368d may enable the end-user to end-activity.

Referring to FIG. 3I-FIG. 3J are example diagrams 300h-300i depicting an admin option 370, in accordance with one or more embodiments. The admin option 370 may provide one or more options whether the team may have an administrator, whether the end-user may be the administrator, and/or rights provided to the administrator. As an example, if the team is a project team, the end-user (e.g., project lead or project manager or human resource manager) might desire to also be the administrator, to easily assign the works to end-users (e.g., employees or colleagues). Similarly, as the administrator, the end-user may desire that other members (e.g., employees or colleagues) cannot override administrator settings, announcements, events, etc. The administrator may override personal member settings to view end-user's presence, location, etc. if the end-user (e.g., project lead or manager or human resource manager) selects the admin option 370, then the diagram 300j may appear.

The diagram 300j depicts a create department option 372, a manage team option 374, a register employee option 376, an update employee option 378, and an update corporate option 380. The create department option 372 may be configured to provide authorizations and tools that are limited to the department to which they have been assigned by the end-user (e.g., enterprise). The department option 372 may be configured to enable the end-user (e.g., project lead or manager or human resource manager) to designate or revoke administrator designations or end-user designations (e.g., an admin department, finance department, management department, sales and marketing department, technology department, etc.). The manage team option 374 may be configured to enable the end-user (e.g., project lead or project manager or human resource manager) to manage or delete the teams (e.g., an admin department, finance department, management department, sales and marketing department, technology department, etc.). The register employee option 376 may be configured to enable the end-user (e.g., project lead or project manager or human resource manager) to create the end-user's credentials (employee's name, date of birth, contact information, designation information, etc.) for registrations. The users may be enabled to set or reset the passwords. If the user forgets the password, the password reset option may be used to decrypt the encrypted password and allow the user to reset the password. The update employee option 378 may be configured to enable the end-user (e.g., project lead or project manager or human resource manager) to update the end-user's credentials (employee's name, date of birth, contact information, designation information, email details, etc.). The update corporate option 380 may be configured to enable the end-user (e.g., enterprise administrator) to update the end-user's credentials (company name, company url, number of employees, annual revenue, tax identity, state, city, email details, contact information, etc.).

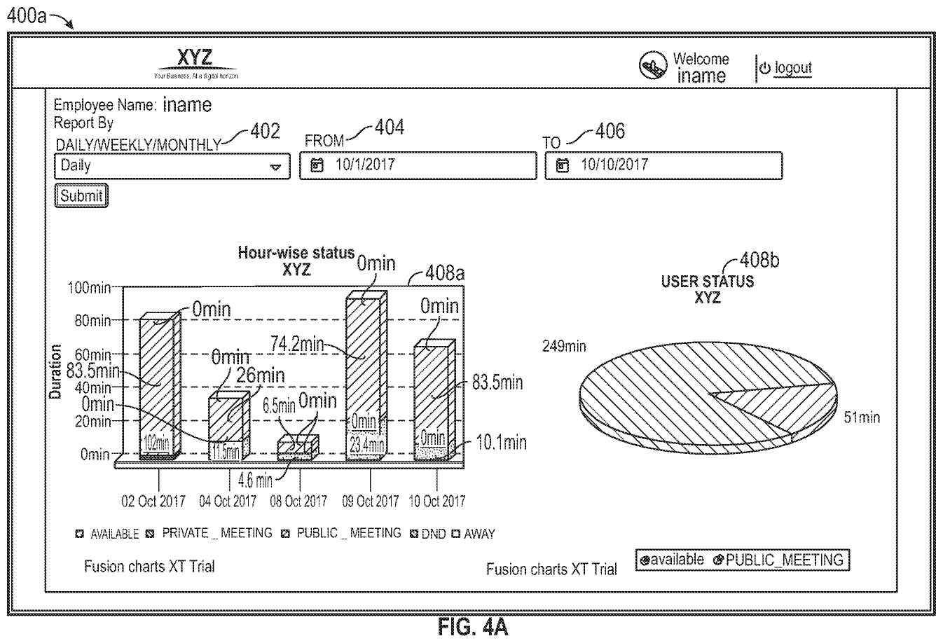

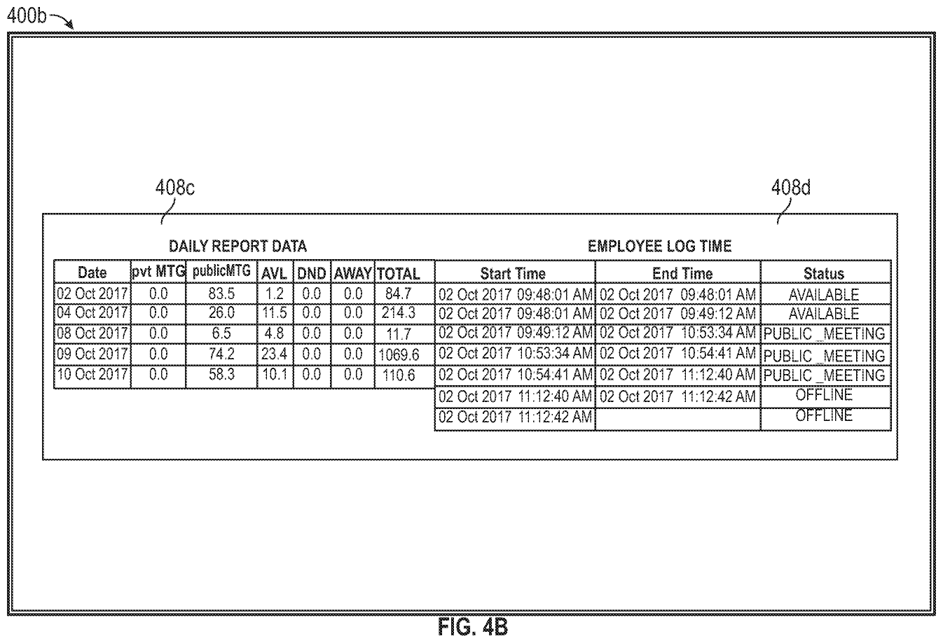

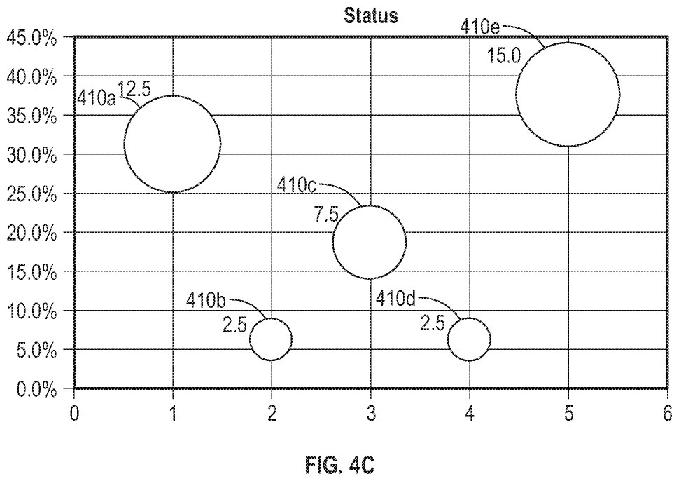

Referring to FIG. 4A-FIG. 4B, FIG. 4A-FIG. 4B are example diagrams 400a-400b depicting the reports option 312 shown in FIG. 3A in accordance with one or more embodiments. If the end-user selects the reports option 312, then the diagram 400a depicts a particular period option 402, a start date option 404, and an end date option 406. The particular period option 402 may include options which are daily, weekly, monthly, yearly, and the like. The start date option 404 may be configured to enable the end-user to select the start date. The end date option 406 may be configured to enable the end-user to select the end date. The example diagrams 400a-400b may further depict collection of visualizations 408a-408d. The visualizations 408a-408d may be configured to depict on a periodic basis (for e.g., daily or weekly or monthly or yearly). The visualizations 408a-408d may include, for example, a column chart, a donut chart, a daily report data table, an employee log time table, and the like. The visualization (the column chart, for e.g.) 408a represents ascending and descending of time duration and date. The visualization (the column chart, for e.g.) 408a may represent time duration of private meeting, public meeting, DND, away, and the like. The visualization (the donut chart, for e.g.) 408b represents different categories. For example, the different categories include available time, public meeting time, and the like. The visualization (the daily report data table, for e.g.) 408c depicts the report data at particular dates. The report data may include time duration of private meeting, public meeting, DND, away, and the like. The visualization (employee log time table, for e.g.) 408d depicts the start time, the end time, and the status.

Referring to FIG. 4C, FIG. 4C is an example diagram 400c depicting a bubble chart, in accordance with one or more embodiments. The bubble chart 400c depicts the end-user's status. The bubble chart 400 depicts indicators (e.g., circles) 410a, 410b, 410c, 410d, and 410e with increasing or decreasing sizes to illustrate the data (e.g., the status) of the end-user. The first larger indicator 410a depicts the end-user's available status (e.g., available hours 12.5, percent 31.3%). The second large indicator 410c depicts the end-user's do-not-disturb status (e.g., do-not-disturb hours 7.5, percent 18.8%). The third large indicator 410e depicts the end-user's public meeting status (e.g., public meeting hours 15.0, percent 37.5%). The first small indicator 410b depicts the end-user's away status (e.g., away status hours 2.5, percent 6.3%). The second small indicator 410d depicts the end-user's private meeting status (e.g., away status hours 2.5, percent 6.3%).

| Status | Hours | Percent |
|---|---|---|
| Available | 12.5 | 31.3% |
| Away | 2.5 | 6.3% |
| Do-not-disturb | 7.5 | 18.8% |
| Private Meeting | 2.5 | 6.3% |
| Public Meeting | 15.0 | 37.5% |

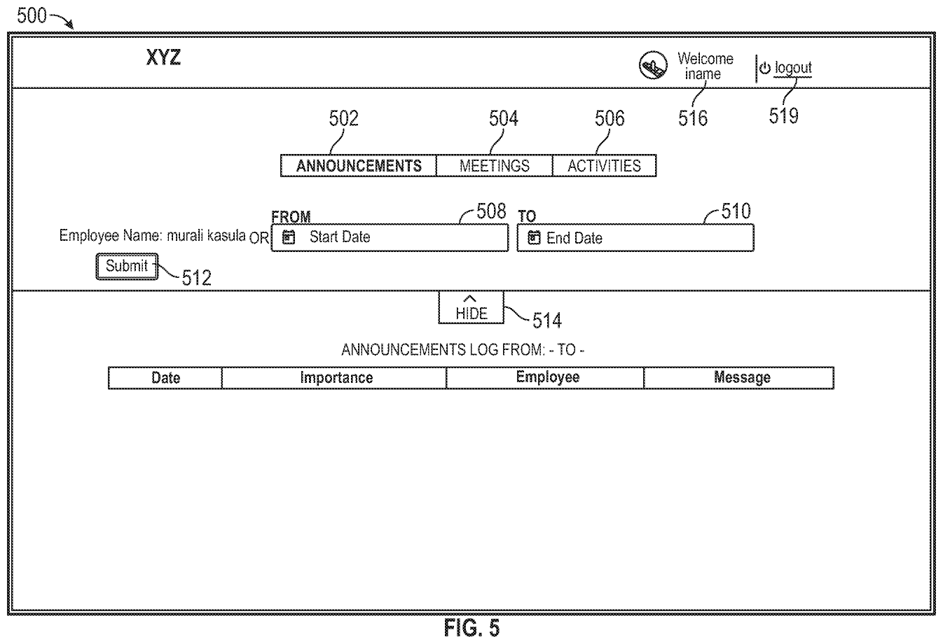

Referring to FIG. 5, FIG. 5 is an example diagram 500 depicting the archives option 314 shown in FIG. 3A in accordance with one or more embodiments. If the end-user selects the archives option 314, then the diagram 500 depicts an announcements option 502, a meetings option 504, an activities option 506, a start date option 508, an end date option 510, a submit option 512, a hide option 514, profile details 516, and a logout option 519. If the end-user selects the announcements option 502, then options (for e.g., the start date option 508, the end date option 510, the submit option 512, the hide option 514, the profile details 516, and the logout option 519) may be displayed on the screen 500. Similarly, if the end-user selects the meetings option 504 and the activities option 506, then options (for e.g., the start date option 508, the end date option 510, the submit option 512, the hide option 514, the profile details 516, and the logout option 519) may be displayed on the screen 500. The start date option 508 may be configured to enable the end-user to select the start date. The end date option 510 may be configured to enable the end-user to select the end date. If the dates are selected, the end-user may tap on the submit option 512 to get visualizations. The visualizations may include, for example, an announcement log report, a meetings log report, an activities log report, and the like. The hide option 514 may be configured to enable the end-user to hide the data on the screen 500. The profile details 516 may be configured to provide the end-user profile details. The logout option 519 may be configured to enable the end-user to log out from the screen 500.

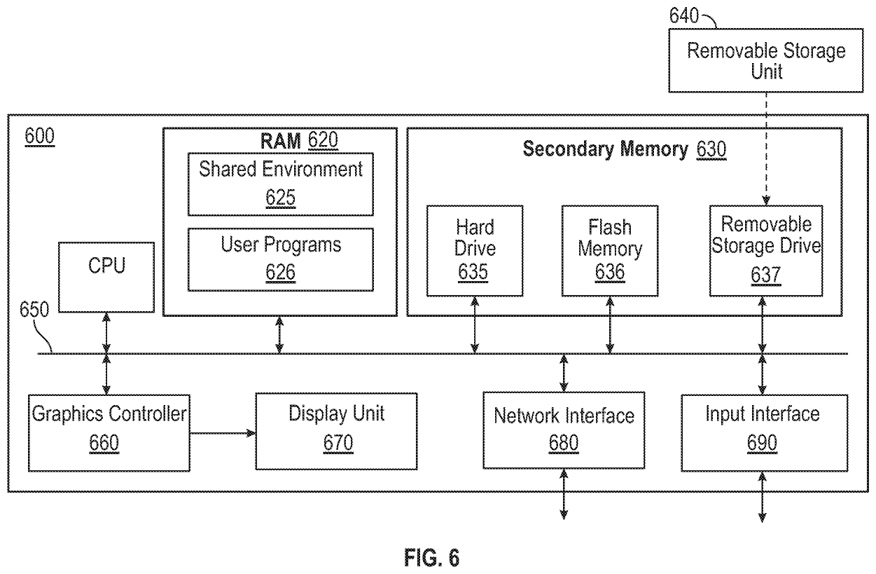

Referring to FIG. 6, FIG. 6 is a block diagram 600 illustrating the details of an end-user device 600 in which various aspects of the present disclosure are operative by execution of appropriate software instructions. The device may correspond to end-user devices such as the computing device 104a-104o (or any other system in which the various features disclosed above can be implemented).

The end-user computing device 600 may contain one or more processors such as a central processing unit (CPU) 610, random access memory (RAM) 620, secondary memory 627, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions, and/or data such as those used in threads and stacks, constituting shared environment 625 and/or user programs 626. Shared environment 625 includes operating systems, device drivers, virtual machines, etc., which provide a (common) run time environment for execution of user programs 626. The RAM 620 may also be configured to store the modules of the data managing platform 102.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. The network interface 680 provides connectivity to a network (e.g., using Internet Protocol), and may be used to communicate with other systems (such as those shown in FIG. 1, network 108 connected to the network.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure. The flash memory 636 may include an electronic non-volatile computer storage medium that can be electrically erased and reprogrammed.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

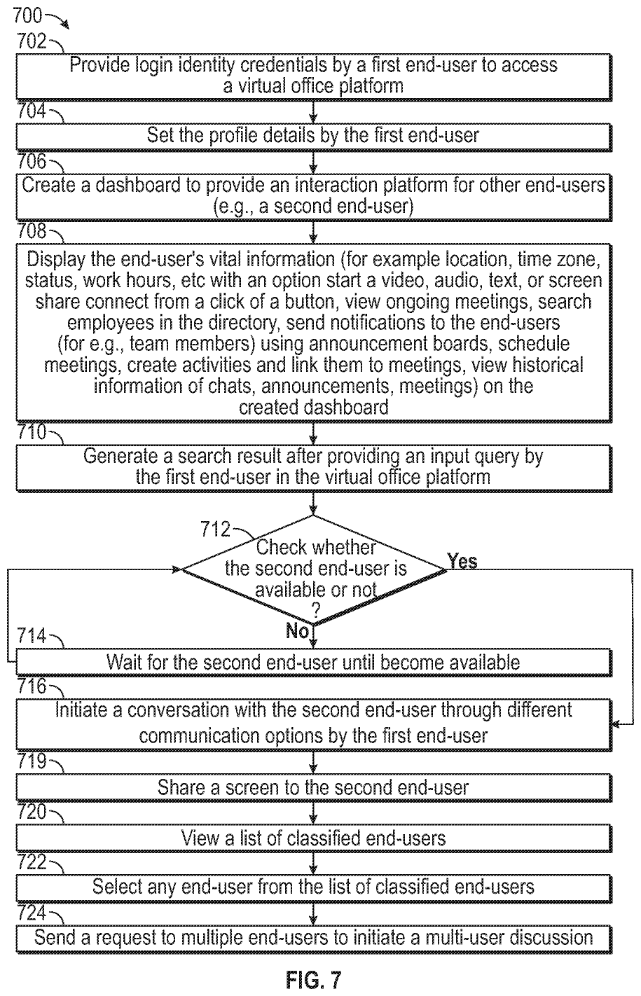

Referring to FIG. 7, FIG. 7 is a flow diagram 700 depicting method for facilitating communications in accordance with one or more embodiments. The method 700 may be carried out in the context of the details of FIG. 1, FIG. 2, and FIG. 3A-FIG. 3F, FIG. 4A-FIG. 4B, FIG. 5, and FIG. 6. However, the method 700 may also be carried out in any desired environment. Further, the aforementioned definitions may equally apply to the description below.

The method commences at step 702, the identity credentials may be provided by the first end-user to access the virtual office management system. Once the virtual office platform is accessed, the first end-user may set the profile details, at step 704. The profile details may include name, change password option, profile picture, work hours, time zone, greet message, and the like. Thereafter, at step 706, a dashboard may be created to provide an interaction platform for other end-users (e.g., a second end-user). Thereafter, at step 708, display the end-user's vital information (for example location, time zone, status, work hours, etc with an option start a video, audio, text, or screen share connect from a click of a button, view ongoing meetings, search employees in the directory, send notifications to the end-users (for e.g., team members) using announcement boards, schedule meetings, create activities and link them to meetings, view historical information of chats, announcements, meetings) on the created dashboard. Thereafter, at step 710, a search may be generated in the virtual office platform after providing an input query by the first end-user. Here, the input query may include, but not limited to, name of employees, name of managers, name of colleagues, and the like. Once the search results are generated, the first end-user may check whether the second end-user is available or not, at step 712. If the answer to step 712 is NO, then at step 714, the first end-user may wait for the second end-user until become available. If the answer to step 712 is YES, then at step 716, the first end-user may initiate a conversation with the second end-user through different communication options. The different communication options may include, but not limited to, a video communication, a data communication, an audio communication, and the like. For example, if the first end-user is working on one project and he can discuss about the project with the second end-user. The first end-user may allow to share the screen to the second end-user, at step 719. The first end-user may view a list of classified end-users, at step 720. The list of classified end-users may include, but not limited to, people online, people offline, people in public meeting, people in private meeting, people away, people with DND, naming A to Z, naming Z to A, and the like. The first end-user may select any end-user from the list of classified end-users, at step 722. Once the list of end-users is selected, the first end-user may send a request to multiple end-users to initiate a multi-user discussion, at step 724. The multiple end-users may include, but are not limited to, a third end-user, a fourth end-user, a fifth end-user, and the like. Here, the first end-user may able to view the different context on the multiple screens of end-users. The different context may include, but is not limited to, status of end-users (for e.g., online or offline), greeting message, location, time zone, work hours, and the like.

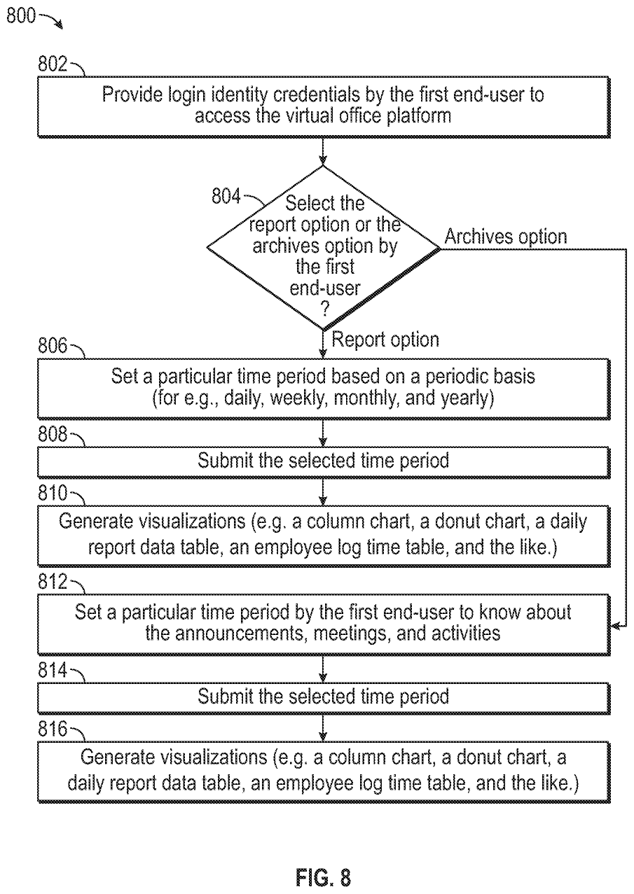

Referring to FIG. 8, FIG. 8 is a flow diagram 800 depicting method for generating visualizations (for e.g., time log reports) in accordance with one or more embodiments. The method 800 may be carried out in the context of the details of FIG. 1, FIG. 2, and FIG. 3A-FIG. 3F, FIG. 4A-FIG. 4B, FIG. 5, FIG. 6, and FIG. 7. However, the method 800 may also be carried out in any desired environment. Further, the aforementioned definitions may equally apply to the description below.

The method commences at step 802, the identity credentials may be provided by the first end-user to access the virtual office management system. Once the virtual office platform is accessed, the first end-user may select the report option or the archives option, at step 804. If the first end-user selected option is report option, then the first end-user may set a particular time period based on a periodic basis (for e.g., daily, weekly, monthly, and yearly), at step 806. The particular time period may include start date, end date, and the like. Once the particular time period is set, the first end-user may submit the selected time period, at step 808. Once the time period is submitted, visualizations may be generated, at step 810. The visualizations may include, but not limited to, analytical reports (for e.g., data tables, report tables, pivot tables, and graphs), and time logs (login time, logout time, meeting time, and ideal time). If the first end-user selected option is the archives option, then the first end-user may set a particular time period to know about the announcements, meetings, and activities, at step 812. Once the particular time period is set, the first end-user may submit the selected time period, at step 814. Once the time period is submitted, the visualizations may be generated, at step 816.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A system for facilitating end-user activities, comprising:
a processor-based application, which when executed on an end-user device, will cause the end-user device to:
login a virtual office platform by at least one first end-user, whereby the first end-user enabled to access a dashboard on the virtual office platform and the dashboard configured to display a plurality of options to initiate a conversation with at least one second end-user by the at least one first end-user through a plurality of different communications, whereby the plurality of options configured to provide the plurality of different communications and the plurality of options comprise at least one video communication option, at least one data communication option, and at least one audio communication option; and
generate search results in the virtual office platform after providing an input query, whereby the input query provided by at least one first end-user;
share a screen to the at least one second end-user by the at least one first end-user, whereby the first end-user configured to select a list of classified end-users and send a request to the selected list to initiate a multi-user discussion.

2. The system of claim 1, wherein the virtual office platform further comprising at least one search generating module configured to generate a search result based on the provided input query.

3. The system of claim 1, wherein the virtual office platform further comprising at least one user's classifying module configured to classify a plurality of end-users in a plurality of formats.

4. The system of claim 1, wherein the virtual office platform further comprising at least one dashboard generation module configured to provide an information about the participation of the plurality of end-users in the multiple meetings.

5. The system of claim 4, wherein the at least one dashboard generation module configured to switch the plurality of end-users to other end-users dashboards.

6. The system of claim 1, wherein the virtual office platform further comprising at least one data enabling module configured to transfer the data between the at least one first end-user and the plurality of end-users.

7. The system of claim 1, wherein the virtual office platform further comprising at least one reference module configured to provide a plurality of quick guide lines to the end-users.

8. The system of claim 1, wherein the virtual office platform further comprising at least one user's connecting module configured to connect with the plurality of end-users.

9. The system of claim 1, wherein the virtual office platform is configured to provide an end-user work related information.

10. A method for facilitating end-user activities, comprising:
logging a virtual office platform on an end-user device by a first end-user, whereby the first end-user enabled to access a dashboard on the virtual office platform and the dashboard configured to display a plurality of options on the end-user device;
generating search results in the virtual office platform after providing an input query, whereby the input query provided by the first end-user;
initiating a conversation with a second end-user by the first end-user through a plurality of different communications, whereby the plurality of different communications provided by a video communication option, a data communication option, and an audio communication option; and
sharing a screen to the second end-user by the first end-user, whereby the first end-user configured to select a list of classified end-users and send a request to the selected list to initiate a multi-user discussion.

11. The method of claim 10, further comprising a step of selecting a report option to set a particular time period based on a periodic basis.

12. The method of claim 11, further comprising a step of generating a plurality of visualizations after submitting the particular time period.

13. The method of claim 10, further comprising a step of selecting an archive option to set a particular time period based on a periodic basis.

14. The method of claim 13, further comprising a step of generating a plurality of visualizations after submitting the particular time period.

15. The method of claim 10, further comprising a step of updating profile details by the first end-user.

16. The method of claim 10, further comprising a step of identifying the plurality of end-users to initiate conversation through the plurality of communication options.

17. The method of claim 10, further comprising a step of notifying a plurality of announcements.

18. The method of claim 10, further comprising a step of selecting a directory option to identify an employee directory, a team directory, a list of employees' directory, and a list of team directory.

19. The method of claim 10, further comprising a step of allowing the plurality of end-users who registered with the virtual office platform to join in a virtual meeting room when a public mode of operation is activated.

20. The method of claim 10, further comprising a step of managing a plurality of meetings comprises at least one of: searching current meetings, viewing current meetings, joining current meetings, and scheduling meetings for automatic joining.

21. The method of claim 10, further comprising a step of managing a plurality of activities comprises at least one of: creating activities, updating activities, and reassigning activities.

22. The method of claim 21, further comprising a step of automatic tracking the spending time against the plurality of activities.

23. The method of claim 10, further comprising a step of adding or registering the plurality of end-users, create new departments and manage team by an admin option.

24. The method of claim 23, further comprising providing a department option, a manage team option, a register employee option, an update employee option, and an update corporate option by the admin option.

25. A computer program product comprising a non-transitory computer-readable medium having a computer-readable program code embodied therein to be executed by one or more processors, the program code including instructions to:
log a virtual office platform on an end-user device by a first end-user, whereby the first end-user enabled to access a dashboard on the virtual office platform and the dashboard configured to display a plurality of options on the end-user device;
generate search results in the virtual office platform after providing an input query, whereby the input query provided by the first end-user;
initiate a conversation with a second end-user by the first end-user through a plurality of different communications, whereby the plurality of different communications provided by an video communication option, a data communication option, and an audio communication option; and
share a screen to the second end-user by the first end-user, whereby the first end-user configured to select a list of classified end-users and send a request to the selected list to initiate a multi-user discussion.
